(19) United States
(12) Patent Application Publication
(10) Pub. No.: US 2026/0155277 A1
(43) Pub. Date: Jun. 4, 2026

(54) CABLE

(71) Applicant: LEONI Kabel GmbH, Roth (DE)

(72) Inventors: Rainer SCHLEHUBER, Ramsberg (DE); Patrick WINTER, Auerbach (DE); Christian ERNST, Weissenburg (DE)

(21) Appl. No.: 19/349,301

(22) Filed: Oct. 3, 2025

(30) Foreign Application Priority Data
Dec. 2, 2024 (EP) 24216908.4

(51) Int. Cl. H01B 3/44

(52) U.S. Cl. CPC H01B 3/44

(57) ABSTRACT

An electrical or optical cable with at least one insulated core and an inner sheath layer comprises an adhesion regulator composition that makes it possible to achieve a reproducible value for the stripping force during the manufacture of the cable and to dispense with the use of powder in cables.

The adhesion regulator composition is part of the core insulation and/or the inner sheath layer and comprises poly(organo)siloxane compounds and fatty acid amides. The cable optionally has an outer sheath layer that is free of the adhesion regulator composition.

### FIELD OF THE INVENTION

The invention relates to an electrical or optical cable comprising at least one insulated core and an inner sheath layer, wherein the inner sheath layer and/or the core insulation of the at least one insulated core comprises a mixture of polymer material and an adhesion regulator composition. The invention further relates to a method for using such an adhesion regulator composition to control the stripping force in a cable.

The cable according to the invention is used in electrical or optical applications, as a sensor cable, or as a signal or data cable.

### BACKGROUND OF THE INVENTION

The stripping force of cables with at least one insulated core represents the force required to separate the sheath layer from the underlying stranded layer, i.e., from the individual cores. The stripping force is an important factor for the smooth automatic processing (cutting to length, crimping, etc.) of a cable.

Factors that influence the stripping force include the pressure in the extrusion head, the material being extruded, and the distance of the cooling tank after the extrusion head. The cores are usually coated with powder to influence the stripping force and improve product manufacturing. To ensure that the powder is distributed evenly on the cores, complex process control is necessary to prevent the stripping force from becoming inhomogeneous across the cable, which could lead to surface defects and sheath cracks. Setting a defined stripping force is therefore generally advantageous. In addition, the use of powder can lead to contamination during production and processing of the cables if appropriate precautions are not taken. Otherwise, harmful contamination from the powder may occur at the place of use and processing of the cable.

The present invention enables reliable and reproducible control of the stripping force in a cable by adding an adhesion regulator to the inner sheath of the cable and/or the core insulation of at least one insulated core during extrusion. The present invention enables an improvement in reproducibility compared to powder-based regulation of the stripping force. Contamination by powder can be avoided.

A composition containing poly(organo)siloxane compounds and fatty acid amides is used as the adhesion regulator.

The use of poly(organo)siloxane compounds and fatty acid amides in cables is known, for example, from EP 2 987 015 B1, wherein this composition is used as a lubricant in the outer sheath to reduce mechanical friction between cables.

### SUMMARY OF THE INVENTION

The invention relates to an electrical or optical cable with at least one insulated core and an inner sheath layer that surrounds the at least one core in direct contact, wherein the inner sheath layer and/or the core insulation of the at least one insulated core comprises a mixture of polymer material and an adhesion regulator composition with poly(organo)siloxane compounds and fatty acid amides.

### DETAILED DESCRIPTION OF THE PREFERRED EMBODIMENTS

The cable according to the invention has at least one insulated core, an inner sheath layer, wherein the inner sheath layer directly surrounds the at least one insulated core, and is characterized in that the inner sheath layer and/or the insulation of the at least one insulated core comprises or consists of a mixture of polymer material and an adhesion regulator composition with poly(organo)siloxane compounds and fatty acid amides. The cable preferably has one or more additional sheaths or layers and/or outer sheath layers without an adhesion regulator composition, which preferably directly or indirectly enclose the inner sheath layer.

The cable has at least one insulated core comprising a conductor and core insulation. The conductor conducts electrical current or light. The core may be electrically conductive material, such as metal, e.g., copper, silver, gold, aluminum, or carbon. The conductor may be a light-conducting material such as glass or plastic. If there are at least two insulated cores, these may be present as a strand in the cable. The core insulation is the insulation of at least one core and comprises or consists of an electrically insulating polymer material, which is a polymer selected from EVA (ethylene vinyl acetate), XLPE (cross-linked polyethylene), PVC (polyvinyl chloride), TPE-S(thermoplastic styrene-butadiene block copolymers), PE (polyethylene), or a mixture thereof, preferably EVA. The core insulation may further contain an adhesion regulator composition, wherein the adhesion regulator composition may be present in an amount of 1 to 15 wt %, preferably 4 to 15 wt %, based on the core insulation.

The polymer material of the core insulation and the adhesion regulator composition are preferably present as a homogeneous mixture.

The cable additionally has an inner sheath layer that surrounds the at least one insulated core in direct contact. The inner sheath layer comprises or consists of a polymer material which may contain a polymer selected from poly polyurethane, polyolefins, thermoplastic elastomers, PVC (polyvinyl chloride), or a mixture thereof, preferably TPE-U, and preferably contains less than 50% by weight, based on the polymer material, of an ethylene-based polymer. It is particularly preferred that the polymer material does not contain any ethylene-based polymer or that the polymer material does not contain at least any polyethylene.

An ethylene-based polymer contains ethylene monomers or ethylene monomer units, for example, it consists of more than 50 wt % ethylene monomers (i.e., ethylene (C₂H₄) was used to produce the polymer). The inner jacket layer may further contain an adhesion regulator composition, wherein the adhesion regulator composition may be present in an amount of 1 to 15 wt %, preferably 4 to 15 wt %, based on the inner jacket layer.

Thermoplastic elastomers describe polymers that exhibit elastic aging at room temperature and can be plastically deformed when heated. Examples are urethane-based thermoplastic elastomers (TPE-U), thermoplastic polyamide elastomers (TPE-A), thermoplastic copolyester elastomers (TPE-E), olefin-based thermoplastic elastomers (TPE-O), thermoplastic styrene block copolymers (TPE-S).

The polymer material of the inner sheath layer and the adhesion regulator composition are preferably present as a homogeneous mixture.

In a cable according to the invention, either the core insulation of the at least one core or the inner sheath layer, or both the core insulation of the at least one core and the inner sheath layer, contain an adhesion regulator composition.

In a preferred embodiment, the inner sheath layer consists of polymer material, optionally containing additives, and the adhesion regulator composition.

If the core insulation of the at least one core contains an adhesion regulator composition, the inner sheath layer may consist of polymer material, optionally containing additives.

In a further preferred embodiment, the core insulation of the at least one core consists of polymer material, optionally containing additives, and the adhesion regulator composition.

If the inner sheath layer contains an adhesion regulator composition, the core insulation of the at least one core may consist of polymer material, optionally containing additives.

Additives may be, for example, coloring pigments, plasticizers, flame retardants, or other substances commonly used in cable manufacturing.

The cable may also contain one or more outer sheath layers surrounding the inner sheath layer. In one embodiment, the (outermost) outer sheath layer does not contain an adhesion regulator composition and preferably contains TPE and particularly preferably TPE-U.

The adhesion regulator composition comprises poly(organo)siloxane compounds and fatty acid amides. Poly(organo)siloxane compounds may be present in the adhesion regulator composition in a proportion of 0.5 wt % to 2 wt %, preferably 1 wt %. Fatty acid amides may be present in the adhesion regulator composition in a proportion of 0.25 wt % to 1 wt %, preferably 0.5 wt %. The adhesion regulator composition comprises poly(organo)siloxane compounds and fatty acid amides in a weight ratio of poly(organo)siloxane compounds to fatty acid amides of 5:1 to 1:1, preferably 4:1 to 2:1, particularly preferably 3:1.

The adhesion regulator composition further comprises poly(organo)siloxane compounds and fatty acid amides, which are preferably bound in a polymer matrix. The polymer matrix preferably consists of a plastic that is compatible with TPE-U, TPE-O, PE, PP, and EVA, and most preferably consists of PE and/or PP.

The term “at least one poly(organo)siloxane compound” means that at least one type (representable by a specific structural formula, wherein the degree of polymerization of different molecules of a type may be different) of a poly(organo)siloxane compound is present and does not mean that at least one molecule thereof is present.

Poly(organo)siloxane compounds are linear, branched, or cyclic molecules, or mixtures thereof, in which silicon atoms and oxygen atoms are alternately bonded. Silicon atoms are generally substituted with two hydrocarbon groups, such as alkyl groups, in particular methyl or ethyl groups. Terminal silicon atoms are substituted with three hydrocarbon groups. Silicon atoms that represent a branch in the molecule are substituted with only one or no hydrocarbon groups. In a preferred embodiment, the poly(organo)siloxane compounds are non-volatile. Non-volatile poly(organo)siloxane compounds have a vapor pressure of less than 2 mm Hg at 20° C.

In a particularly preferred embodiment, dimethylsilicone compounds are used as poly(organo)siloxane compounds. Dimethylsilicone compounds are characterized in that the hydrocarbon groups substituted on the silicon atoms are methyl groups (—CH₍₃). An example of a dimethylsilicone compound is polydimethylsiloxane (PDMS, dimethicone).

The molar masses of the poly(organo)siloxane compounds can be between 10,000 and 500,000 g/mol, preferably between 30,000 and 400,000 g/mol, particularly preferably between 50,000 and 300,000 g/mol, and especially preferably between 80,000 and 300,000 g/mol.

The term “at least one fatty acid amide” means that at least one type (representable by a specific structural formula) of a fatty acid amide is present and does not mean that at least one molecule thereof is present. Fatty acid amides are organic molecules that carry an amide group and are structurally derived from a fatty acid.

Primary fatty acid amides are preferably used in the cable according to the invention. In primary fatty acid amides, there is exactly one acyl group on the amide nitrogen. The amide nitrogen can carry two, one, or no organic groups in addition to the fatty acid molecule residue.

Examples of fatty acid amides are: valeric acid amide, caproic acid amide, enanthic acid amide, caprylic acid amide, pelargonic acid amide, capric acid amide, undecanoic acid amide, lauric acid amide, tridecanoic acid amide, myristic acid amide, pentadecanoic acid amide, palmitic acid amide, heptadecanoic acid amide, stearic acid amide, nonadecanoic acid amide, arachidic acid amide, behenic acid amide, lignoceric acid amide, cerotic acid amide, palmitoleamide, oleamide, linoleamide, linolenamide, gadoleamide, arachidonamide, eicosapentaenamide, erucamide, docosahexaenoic acid amide, nervonic acid amide, preferably erucic acid amide (synonym: erucic acid amide) and stearic acid amide, particularly preferably erucic acid amide, or mixtures thereof, wherein these fatty acid amides may have two, one or no organic groups adjacent to the fatty acid molecule residue on the amide nitrogen.

The cable according to the invention preferably contains no powder between the layers of the cable, in particular there is preferably no powder, in particular no adhesion regulator powder, between the at least one insulated core or a stranding of several insulated cores and the inner sheath layer. Adhesion regulator powder describes any powdered material used in the cable to influence the stripping force.

The cable according to the invention can be used in electrical or optical applications, as a sensor cable, or as a signal or data cable.

The cable design described herein allows a defined stripping force to be set. The stripping force of single-core or multi-core cables represents the force required to separate the inner sheath layer from the underlying core or the “stranded layer” (individual cores). The stripping force is defined over a defined length of the cable to be tested and with a defined pulling speed of the sheath from the at least one core or the stranding of several cores, and is specified in newtons [N] with a tolerance range of usually 15-25 N.

A cable according to the invention preferably has a stripping force of less than 70 newtons, preferably less than 60 newtons, particularly preferably less than 50 newtons, after 700 hours of storage (25° C.; 50% RH). The measurement is preferably carried out over a pull-off length of 30 mm-100 mm and a pull-off speed of 30-250 mm/min. The determined stripping force preferably has a standard deviation of less than 3.0, preferably less than 2.0, and particularly preferably less than 1.0.

The adhesion regulator composition preferably has no tendency to migrate, whereby the adhesion regulator composition does not accumulate on the surface of the outer sheath layer. The measurement is preferably carried out by means of SEM-EDX by analyzing the surface of the outer sheath layer of the cable after storage for 3000 hours at 125° C. and comparing the detected element composition with a cable without an adhesion regulator composition. In particular, a difference in the silicon concentration on the surface of the outer sheath layer would indicate migration of the adhesion regulator composition.

The cables according to the invention can pass winding tests at low temperatures, stress tests, and 90° flexural fatigue tests in both unaged and aged conditions. They can pass stress tests with thermal overload of up to 195° C. for 6 hours. The sheath material (outer sheath layer and inner sheath layer with adhesion regulator composition) can exhibit good values for tensile strength and elongation at break before and after aging.

FIG. 1 schematically shows the cross-section of a cable according to the invention with (1) two insulated cores, (2) the inner sheath layer, which surrounds the two cores in direct contact, and (3) an outer sheath layer, which surrounds the inner sheath layer. The core insulation of the cores and/or the inner sheath layer contain an adhesion regulator composition as described above.

The invention further relates to the use of an adhesion regulator composition comprising poly(organo)siloxane compounds and fatty acid amides in a mixture with an electrically insulating polymer as the core insulation of an electrically insulated core and/or as an inner sheath layer in direct contact with the electrically insulated core, for controlling the stripping force in a cable as described above.

By using an adhesion regulator composition, the cable preferably has a stripping force, measured over a pull-off length of 30 mm-100 mm and a pull-off speed of 30-250 mm/min, with a spread width of maximum 5.0 newtons after a maximum storage period of 6 months. The determined standard deviation is preferably less than 3.0, preferably less than 2.0, and particularly preferably less than 1.0.

The control of the stripping force describes that a desired stripping force can be achieved in a targeted and reproducible manner during the manufacture of the cable. The invention described here thus enables the manufacture of cables with a narrowly defined stripping force. A stripping force outside the desired specification can lead to increased scrap production, machine failure, or the need for manual rework during further processing. They also cause extra work, customer complaints, and higher waste rates. These disadvantages can be avoided by reproducibly setting an advantageous stripping force for the cable.

In addition, the use of the adhesion regulator composition eliminates the need for powder to control the stripping force, which avoids the disadvantages of using powder, in particular the risk of surface defects and contamination of the machines at the cable manufacturing site and the environment at the cable processing site (cutting to length, crimping, etc.).

### DESCRIPTION OF THE FIGURE

FIG. 1: Cross-section of a cable according to the invention. The insulated cores (1) are surrounded by the inner sheath layer (2) in direct contact. The inner sheath layer is surrounded by an outer sheath layer (3). The inner sheath layer (2) and/or the core insulation of the cores (1) contain the adhesion regulator composition described herein.

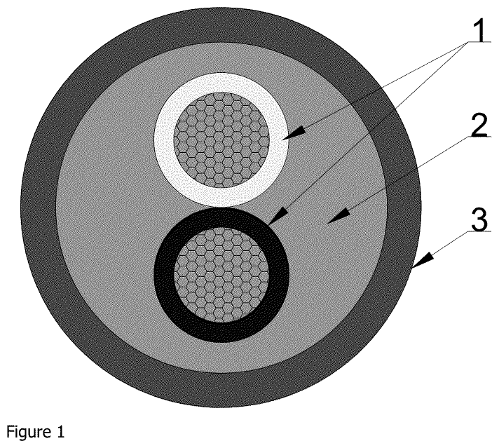

### EXAMPLES

### Example 1: Preparation

A cable according to the invention with a proportion of an adhesion regulator composition in the inner sheath layer of 10% by weight was manufactured by adding the adhesion regulator composition (containing dimethyl silicone compounds approx. 1% and erucic acid amide as a fatty acid) to the polymer material of the inner sheath layer (TPE-U, thermoplastic elastomer based on polyurethane) was added to the polymer material of the inner sheath layer (TPE-U, polyurethane-based thermoplastic elastomer) via a dosing unit and mixed homogeneously in the dosing unit and in a single-screw extruder. The mixture was extruded in the extruder head of the single-screw extruder as an inner jacket layer onto a sensor cable (2 cores, EVA core insulation material). In a second step, an outer jacket layer (TPE-U, polyurethane-based thermoplastic elastomer) was extruded onto the inner jacket layer.

### Example 2: Stripping Force

The stripping force of a cable according to the invention from Example 1 (cable 1) was measured at specific times over a period of 6 months and compared with a cable with powder (fatty acid-containing substances) between the cores and the inner sheath layer without the adhesion regulator composition according to the invention (cable 2).

The stripping force can be determined by cutting into the sheath and inner sheath layer at the end of a cable to be tested, securing the cable and the core in a suitable apparatus, attaching a force measuring device either to the cable or to the core, and recording the force achieved when the core is pulled out of the cable (stripped). The measurement was performed automatically with identical measurement parameters over a pull-off length of 50 mm at a pull-off speed of 50 mm/min. The force determined (in Newtons) is listed in Tablet.

TABLE 1
Time curve of the stripping force of a cable
according to the invention in newtons.

| | | | | | |
|---|---|---|---|---|---|
| Storage period | MIN | MAX | AVG | StAbw. | N |

| | | | | | | |
|---|---|---|---|---|---|---|
| 24 | h | 9.8 | 12.6 | 11 | 0.7 | 53 |
| 1 | week | 9.7 | 13.9 | 11.2 | 0.9 | 48 |
| 2 | weeks | 10 | 13.3 | 11.3 | 0.8 | 48 |
| 4 | weeks | 10.8 | 14.8 | 12.7 | 0.9 | 50 |
| 2 | months | 10.3 | 15.2 | 11.8 | 1 | 93 |
| 3 | months | 11.0 | 17.3 | 13.4 | 1.4 | 49 |
| 6 | months | 10.6 | 15.5 | 13.0 | 1.4 | 49 |

| | | | | | |
|---|---|---|---|---|---|
| Cable 2 | 8.0 | 54.6 | 33.6 | 8.9 | 1722 |

* Number of samples.

Compared to the cable without the adhesion regulator composition according to the invention, significantly lower average stripping forces with standard deviations of less than 2.0, in some cases less than 1.0, were determined.

### Example 3: Examination of the Surface for Migration

A cable according to the invention (cable 1) and a comparison cable (cable 2) according to Example 2 were stored for 3000 hours at 125±3° C. The tendency of the adhesion regulator composition to migrate from the inner sheath layer to the cable surface was examined using SEM/EDX.

After aging, a lubricating film could be detected microscopically on the cable surfaces of both cables. Using SEM-EDX analysis, only organic components originating from the outer sheath material could be detected. No increased amount of silicon, and thus silicone compounds originating from the adhesion regulator composition, was detected on the sheath surface of cable 1 compared to the reference cable 2. Thus, the lubricating film did not contain any detectable amount of adhesion regulator composition and a tendency of the adhesion regulator composition to migrate could be ruled out.

### Example 4: Long-Term Aging

A cable according to the invention (cable 1) and a comparative cable (cable 2) according to Example 2 were subjected to a winding test at room temperature and a tension test according to ISO 19642 after 1000, 2000, 2500, and 3000 hours of storage at 125±3° C., a winding test at room temperature and a tension test according to ISO 19642-2:2019-01; DIN EN 60811-509:2018-05.

The winding test was performed on a mandrel with a diameter of 25.5 mm, a weight of 5 kg and a speed of 0.2 s⁻¹. In the tension test, a voltage of 2 kV was applied for 3 seconds.

No cracks or breaks were found in either cable 1 or cable 2 in any of the winding tests. There was no breakdown in any of the voltage tests.

### Example 5: Thermal Overload

A cable according to the invention (cable 1) and a comparison cable (cable 2) according to Example 2 were subjected to a winding test at room temperature and a tension test according to ISO 19642-2:2019; DIN EN 60603-1-2:2019 after being stored for 6 hours in a suspended state at 175±3° C., 185±3° C., 195±3° C., and 205±3° C., respectively, were subjected to a winding test at room temperature and a tension test in accordance with ISO 19642-2:2019; DIN EN 60811-509:2018-05. The winding test was performed on a mandrel with a diameter of 25.5 mm, a weight of 5 kg, and a speed of 0.2±⁻¹. During the tension test, a voltage of 2 kV was applied for 3 seconds.

No cracks or breaks were found in either cable 1 or cable 2 in any of the winding tests up to and including 195±3° C., and there was no breakdown in any of these voltage tests.

As a result of the tests at 205±3° C., the sheath layers of the cables melted.

### Example 6: Thermal Shock

A cable according to the invention (cable 1) and a comparison cable (cable 2) according to example 2 were subjected to a winding test in accordance with ISO 19642-2:2019; DIN EN 60811-509:2018-05.

The winding test was performed on a mandrel with a diameter of 13 mm. No cracks or breaks were found in either cable 1 or cable 2 in any of the winding tests up to and including 195±3° C. As a result of the tests at 205±3° C., the sheath layers of the cables melted.

### Example 7: Winding Test at Low Temperature

A cable according to the invention as per Example 1 (cable 1) and a cable according to the invention after short-term aging for 240 hours at 150±3° C. (cable 3) were subjected to a winding test at room temperature and a tension test for 4 hours at −40° C. (cable 1) and −25° C. (cable 3), respectively. The winding test was performed on a mandrel with a diameter of 25 mm, a weight of 5 kg, and a speed of 0.2 s⁻¹. In the tension test, a voltage of 2 kV was applied for 3 seconds.

No cracks or breaks were found in any of the winding tests for either cable 1 or cable 3. There was no breakdown in any of the voltage tests.

### Example 8: Tensile Strength of the Sheath Material

The tensile strength and elongation at break were determined for a sheath material according to the invention (sheath 1), consisting of an inner sheath layer with an adhesion regulator composition (analogous to Example 1) and an outer sheath layer (analogous to Example 1) and an identical sheath material according to the invention after short-term aging for 240 hours at 150±3° C. (sheath 2). The measurement was carried out in accordance with DIN EN 60811-501:2019-04; ISO14572:2011-10-01 at a speed of 250 mm/min. The results are listed in Table2.

TABLE 2
Results of the tensile strength test.

| | | Tensile strength, | Elongation |
|---|---|---|---|
| | | N/mm² | at break, % |
| Sheath 1 | min. | 47.7 | 506 |
| | med. | 51.5 | 523 |
| | max. | 52.2 | 548 |
| Jacket 2 | min. | 19.9 | 406 |
| | med. | 21.5 | 455 |
| | max. | 22.4 | 457 |

1. Cable comprising:
at least one insulated core,
an inner sheath layer, wherein the inner sheath layer surrounds the at least one insulated core in direct contact,
characterized in that
the inner jacket layer and/or the insulation of the at least one insulated core comprises a mixture of polymer material and an adhesion regulator composition, wherein the adhesion regulator composition contains at least one poly(organo)siloxane compound and at least one fatty acid amide, and
optionally, one or more additional jackets and/or outer jacket layers without adhesion regulator composition.

2. Cable according to claim 1, wherein the cable does not comprise powder, in particular there is no powder, in particular no adhesion regulator powder, between the at least one insulated core and the inner sheath layer.

3. Cable according to claim 1, wherein the cable is suitable for use as a sensor cable.

4. Cable according to claim 1, wherein the polymer material of the insulation of the at least one core comprises a polymer selected from EVA (ethylene vinyl acetate), XLPE (cross-linked polyethylene), PVC (polyvinyl chloride), TPE S (thermoplastic styrene-butadiene block copolymers), PE (polyethylene), or a mixture thereof, preferably EVA.

5. Cable according to claim 1, wherein the polymer material of the inner sheath layer comprises a polymer selected from polyurethane, polyolefins, thermoplastic elastomers, PVC (polyvinyl chloride), or a mixture thereof, preferably TPE-U, and preferably contains less than 50 wt %, based on the polymer material, of an ethylene-based polymer, in particular polyethylene.

6. Cable according to claim 1, wherein the inner sheath layer and/or the insulation of the at least one core consists of a polymer material optionally containing additives and the adhesion regulator composition.

7. Cable according to one claim 1, wherein the mixture of the polymer material and the adhesion regulator composition of the inner sheath layer and/or the mixture of the polymer material and the adhesion regulator composition of the insulation of the at least one core is homogeneous.

8. Cable according to claim 1, wherein the adhesion regulator composition is present in the inner sheath layer in an amount of 1 to 15 wt. %, preferably 4 to 15 wt. %, based on the inner sheath layer, and/or in the insulation of the at least one core in an amount of 1 to 15 wt. %, preferably 4 to 15 wt. % based on the insulation of the at least one core, wherein the adhesion regulator composition preferably comprises 1 wt. % of the at least one poly(organo)siloxane compound and 0.5 wt. % of the at least one fatty acid amide.

9. Cable according to claim 1, wherein the adhesion regulator composition comprises the at least one poly(organo)siloxane compound and the at least one fatty acid amide in a weight ratio of 5:1 to 1:1.

10. Cable according to claim 1, wherein the at least one poly(organo)siloxane compound is a dimethylsilicone compound, and/or the at least one poly(organo)siloxane compound has a molecular weight between 10,000 and 500,000 g/mol.

11. Cable according to claim 1, wherein the cable has a stripping force, measured over a pull-off length of 30 mm-100 mm and a pull-off speed of 30-250 mm/min, of less than 70 newtons after 700 hours of storage, preferably with a standard deviation of less than 3.0, preferably less than 2.0, particularly preferably less than 1.0.

12. Cable according to claim 1, wherein after 3000 hours at 125° C., the adhesion regulator shows no tendency to migrate, as analyzed by SEM-EDX, wherein the adhesion regulator composition does not accumulate on the surface of the outer sheath layer.

13. Use of an adhesion regulator composition comprising at least one poly(organo)siloxane compound and at least one fatty acid amide, in a mixture with an electrically insulating polymer as insulation for at least one electrically insulated core and/or as an inner sheath layer in direct contact with the at least one electrically insulated core, for controlling the stripping force in a cable according to claim 1.

14. Use of an adhesion regulator composition according to claim 13, wherein the cable has a stripping force, measured over a pull-off length of 30 mm-100 mm and a pull-off speed of 30-250 mm/min, with a spread width of maximum 5.0 Newton after a maximum storage period of 6 months, preferably with a standard deviation of less than 3.0, preferably less than 2.0, particularly preferably less than 1.0.
